(19) United States
(12) Patent Application Publication
(10) Pub. No.: US 2007/0077814 A1
(43) Pub. Date: Apr. 5, 2007

(54) Connector

(75) Inventors: Jonathan Sullivan, Lincoln, NE (US); Monty Rohde, Lincoln, NE (US)

Correspondence Address: HOLLAND & HART, LLP, P.O BOX 8749, DENVER, CO, 80201, US

(73) Assignee: Centurion Wireless Technologies, Inc.

(21) Appl. No.: 11/241,077

(22) Filed: Sep. 30, 2005

(51) Int. Cl. H01R 9/05

(52) U.S. Cl. 439/581

(57) ABSTRACT

The present invention provides a connector useful to attach a coaxial cable power feed to a device. The connector assembly comprises a connector body and a connector top. The connector body and connector top are coupled with an open and an engaged position. In the engaged position, a power contact interfaces with the central conductor of the cable and the device to provide power to the device. Further, a ground contact engages the shield of the cable and the ground plane to provide a ground. Finally, the device either snaps or is soldered to the device, minimizing the need for expensive coupling equipment.

### FIELD OF INVENTION

The present invention relates to antenna connectors and, more particularly, a connector to facilitate connecting a coaxial cable to a device and/or an appliance.

### BACKGROUND OF THE INVENTION

Among other things, a radio frequency (“RF”) transmission line carries RF energy from an antenna to a transmitter, a receiver, or a transceiver in a wireless system. The quality of the transmission line and the way it is attached to the radio or antenna has an effect on system performance.

A pair of wires running parallel to and insulated from each other comprises a simple transmission line. Conductor material, wire size, and distance between the wires influences the efficiency of the transmission line. This type of transmission line is called a balanced line. Other types of balanced transmission lines are of course possible and known in the art.

An un-balanced line is another type of transmission line. The un-balanced line may include a wire (center conductor) that is placed inside of another conductor (shield) with an insulator between, such as, for example, a coaxial cable transmission line. Other types of un-balanced transmission lines are of course possible and known in the art.

Coaxial cable transmission lines are connected to the device/appliance (device and appliance are used interchangeably herein) by using coaxial cable connector sets that include a male end and a female end.

Typically, the male end and female end are attached to the device by having one soldered and/or crimped to the coaxial cable and the other soldered and/or crimped to the device. Threaded, snap features, or the like features mechanically couple the male end and female end.

The inside and outside conductors of the male end are electrically and mechanically connected to the inside and outside conductors of the female end, respectively, either by an interference fit, threaded features, or the like. Coaxial connectors are made from a combination of metal and plastic components. Like the feed line, coaxial connectors must be designed and fabricated properly or will cause system performance to degrade. Coaxial connectors are expensive to make and difficult to install. In many cases they cannot be installed in the field because they require special equipment, such as, for example, crimper machines, holding fixtures, and the like, to install the connector. Thus, it would be desirous to develop an improved coaxial connector.

### SUMMARY OF INVENTION

To attain the advantages of and in accordance with the purpose of the present invention, a coaxial connector is provided. The coaxial connector includes a connector body and a connector top. The connector top is a reference for convenience and top is used as a relative feature and not in the absolute. The connector top is fittingly engaged, which may be removably, slidably, or pivotally, to the connector body such that the connector assembly has an open position and an engaged position. The connector body and the connector top define a channel when in the engaged position that may receive a power feed having a ground portion and a conductor portion. The ground portion is connected to a ground contact on the connector and the power feed is coupled to a power contact coupled to the connector. Insulation is provided to insulate the power contact and the ground contact, the ground plane, and the ground portion.

The foregoing and other features, utilities and advantages of the invention will be apparent from the following more particular description of an embodiment of the invention as illustrated in the accompanying drawings

### BRIEF DESCRIPTION OF DRAWINGS

The above and other objects and advantages of the present invention will be apparent upon consideration of the following detailed description, taken in conjunction with the accompanying drawings, in which like reference characters refer may be used to refer to like parts throughout, and in which:

FIG. 1 shows an isometric view of a coaxial connector in accordance with an embodiment of the present invention;

FIG. 2 shows an exploded view of the coaxial connector of FIG. 1;

FIG. 3 shows the coaxial connector of FIG. 1 with in the open position;

FIG. 4 shows the coaxial connector of FIG. 1 attached to a printed circuit board and a coaxial cable;

FIG. 5 shows an isometric view of a coaxial connector in accordance with another embodiment of the present invention;

FIG. 6 shows an isometric view of the coaxial connector of FIG. 5 connected to a printed circuit board and a coaxial cable;

FIG. 7 shows an exploded view of the coaxial connector of FIG. 5;

FIG. 8 shows another view of the coaxial connector of FIG. 5;

FIG. 9 shows a schematic diagram of a printed circuit board adapted to receive the coaxial connector of FIG. 5;

FIG. 10 shows a cross-sectional view showing an alternative construction of the coaxial connector of FIG. 1;

FIG. 11 shows a partially exploded view of a coaxial connector in accordance with another embodiment of the present invention;

FIG. 12 shows another view of the coaxial connector of FIG. 11;

FIG. 13 shows a conventional coaxial cable usable with the embodiments of the present invention;

FIG. 14 shows an isometric view of the coaxial connector of FIG. 1 with an alternative construction;

FIG. 15 shows an isometric view of a coaxial connector in accordance with another embodiment of the present invention;

FIG. 16 shows the coaxial connector of FIG. 15;

FIG. 17 shows an isometric view of a coaxial connector in accordance with another embodiment of the present invention;

FIG. 18 shows the coaxial connector of FIG. 17;

FIG. 19 shows an isometric view of a coaxial connector in accordance with another embodiment of the present invention;

FIG. 20 shows an isometric view of a coaxial connector in accordance with another embodiment of the present invention; and

FIG. 21 shows an exploded view of the coaxial connector of FIG. 20.

### DETAILED DESCRIPTION

As a generally overview and non-limiting explanation, the basic concept of the new invention comprises a coaxial connector that facilitates installing a coaxial cable and/or mating device and is less costly to produce and/or purchase. Ideally, such a device would have the same or more reliable performance than existing designs.

The present invention consists of many different variations, some of which are described in this application by way of non-limiting examples. One of ordinary skill in the art will recognize that other variations are possible. In one version, a coaxial connector may be attached to a device, such as, for example, a radio, an antenna, or a printed circuit board. For ease of reference, most examples to follow will include attachment to a printed circuit board, but this should not be considered a limitation on the connector. The connector is placed on to the surface of the device and connected electrically and mechanically. The connection may be by any conventional connection means, such as mechanical connection, like a press fit connection, snap connection, friction fitting, threaded connection, or the like, a weld connection, like a solder connection, or the like. The coaxial cable is then partially stripped of its insulation and shield then placed into the connector body. A top latch is closed on the body thus capturing the coaxial cable partially stripped and making electrical contact with the outside shield of the coaxial cable. Also, while the top latch is closed the center conductor and insulation is forced into an insulation displacement contact by a feature in the top latch cap. When the center conductor and insulator are forced into position the insulation is separated by the insulation displacement contact and the center conductor is then forced in the slot in the contact thus making electrical contact. Unlike existing connector sets, this invention requires only one connector to attach coaxial cable to a device.

Another embodiment, and again by way of a generally description for background and non limiting example, may comprise an RF connector that is attached directly to the coaxial cable and then at anytime will be snapped to the device, be it the radio, the antenna, the cellular telephone, the PDA, computer, or the like requiring a coaxial. Unlike existing connector sets, this invention requires only one connector to attach coaxial cable to a device. No mating connector is necessary. In this embodiment, the coaxial cable is partially stripped of its insulation and shield and placed into the connector body. The top latch is placed over the connector body and pressed into the latched position. When it is latched, the cable is captured between the two connector halves and making electrical contact with the outside shield. Also, while the connector top is being pressed into the latched position the center conductor and insulation are forced into the contact. The contact penetrates the center insulation and the center conductor is forced into the slot in the contact thus making an electrical connection. Anytime after this connector is installed the coaxial cable/connector assembly can be snapped on the radio, printed circuit board or any other application that requires coaxial cable. The connector is mechanically attached to the device by means of cantilever type beams extending from the connector top and protruding into special hook slots in the device. The center conductor makes electrical connection by the contact touching the feed pad on the device. The shield makes contact through a second contact to the printed circuit board.

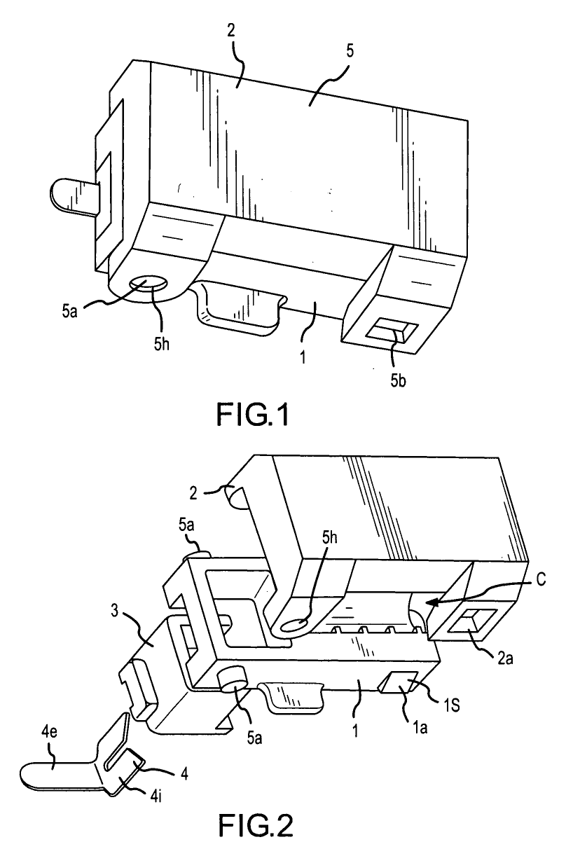

Referring first to FIG. 1, a coaxial cable connector 5 constructed in accordance with the present invention is shown. Connector 5 is shown unattached to either a device, such as a printed circuit board, or a transmission line, such as a coaxial cable. Connector 5 is shown closed and may be latched or locked in the closed position, as will be explained further below.

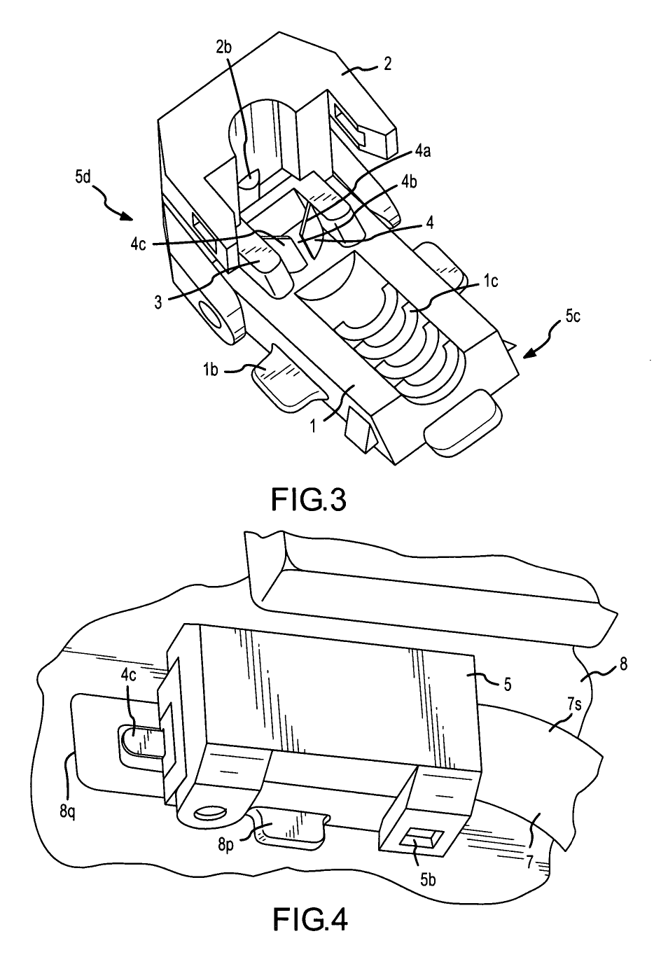

In this embodiment, coaxial cable connector 5 may be electrically and mechanically attached to a printed circuit board, radio, antenna or any other device requiring connection to a coaxial cable. FIG. 4 shows coaxial cable connector 5 attached to a printed circuit board 8 and a coaxial cable 7. An electrical connection between coaxial cable connector 5 and printed circuit board 8 is established by soldering a solder tab 1b on a connector body 1 of coaxial cable connector 5 (shown in FIG. 4, but best seen and labeled in FIG. 3) to a solder pad 8p on printed circuit board 8. One of ordinary skill in the art would recognize other electrical connections are possible instead of solder connections, such as, for example, using a threaded screw to screw the contact to the printed circuit board, using a rivet through a hole in the contact and the printed circuit board, using folded over ears to provide contact between the connector body and the printed circuit board, using spring contacts or interference contacts, or the like. Solder tab (or tabs) 1b and solder pad 8p provide an electrical path from the outer surface, or shield 7b (shown in FIG. 13) of coaxial cable 7 to a ground plane, which is typically printed circuit board 8. A second solder tab 4c on a contact 4 (explained further below) is soldered to a second solder pad 8q on printed circuit board 8. This provides an electrical path for center conductor 7d (shown in FIG. 13) of coaxial cable 7 to the second solder pad 8q on printed circuit board 8 or other device. This is typically used as the feed.

Referring now to FIGS. 1 and 2, the components of connector 5 will be further explained. Specifically FIG. 1 shows connector 5 in the closed or latched position while FIG. 2 shows an exploded view of connector 5. Connector 5 includes the connector body 1, the connector top 2, one or more hinge points 5a or pivot points.

Points 5a may be one or more protrusions as shown, an axle, rod, or the like as a matter of design choice. Points 5a provide a means for which body 1 and top 2 may pivot between the closed position (FIG. 1) and the open position (FIG. 3).

Connector 5 may include a latch 1a or lock, which also is shown as a protrusion on body 1. Latch 1a fits into a corresponding latch hole 2a or dimple on top 2. As shown, latch 1a has an angled surface 1s that assists top 2 fit over latch la until latch 1a can fit in hole 2a. Conversely or complementary to surface 1s, top 2 may have an angled surface to facilitate the latching.

Body 1 may be constructed from an electrically conductive material. For example, body 1 may be constructed from machined or die cast metal. Alternatively, body 1 may be molded plastic and plated. Body 1 and top 2 may be connected by snapping pivot holes 5h on connector top onto hinge points 5a in this embodiment.

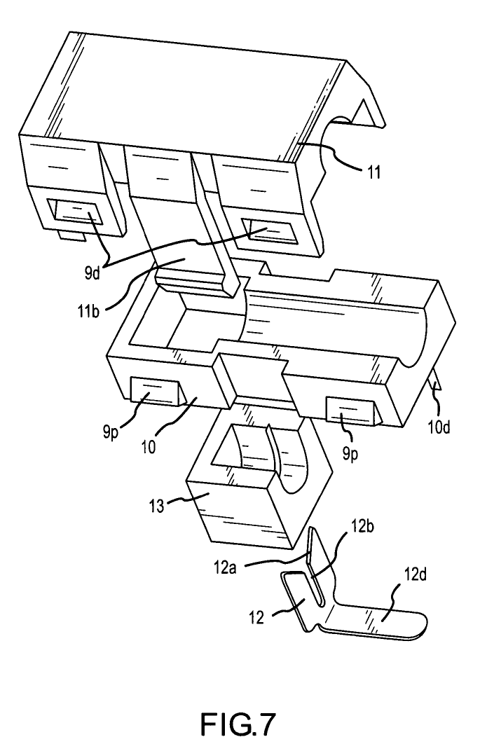

In particular, holes 5h are snapped onto hinge points 5a protrusions. Alternatively, a pin, screw, axle, or the like may be replaced for protrusions as hinge points 5a such that top 2 is connected to body 1 without snapping holes onto protrusions. Generally, top 2 also may be constructed from electrically conductive material or plated plastics. An insulative material 3 resides at a first end of connector 5. Insulative material 3 insulates contact 4 from body 1 and top 2. Contact 4 has a portion 4i that resides internal to connector 5 and a portion 4e that resides external to connector 5. Insulative material 3 may be any material, such as, for example, Teflon, polyethylene, or the like. Contact 4 is made from an electrically conductive material, such as, for example, copper or the like. As will be further explained below, contact 4 provides an electrical path from center conductor 7d (FIG. 7) to the device, such as printed circuit board 8 (FIG. 4). As first seen in FIG. 2, body 1 and top 2 form a channel C in which coaxial cable 7 resides.

Referring now to FIG. 3, parts internal to connector 5 will be explained. Connector 5 has a device end 5d and a cable end 5c. Contact 4 resides proximate device end 5d. Internal portion of contact 4 includes two extensions 4c terminating in leading edges 4a. Leading edges 4a may be considered a knife-edge as will be explained below. Residing between extensions 4c is a slot 4b. When pressed into channel C, leading edges 4a cut through the layers of coaxial cable 7 allowing center conductor 7d to fit into slot 4b forming an electrical connection between center conductor 7d and second solder pad 8q via contact 4. In this design, coaxial cable 7 is partially stripped; however, alternative designs may allow for use without actually stripping cable 7. Channel C further has one or more teeth 1 c or protrusions, ribs, or the like, that assist in grabbing cable 7 to inhibit cable 7 from pulling out of or slipping from of channel C. Alternative methods to increase the frictional engagement of top 2 and body 1 about cable 7 include using adhesives, surface roughening, or the like.

Specifically, during use, connector 5 is typically soldered to printed circuit board 8 prior to installing cable 7; however, connector 5 could be attached to cable 7 first if desired. Once attached to board 8 and solder, cable 7 is partially stripped to expose a portion of inside insulator 7c. Inside insulator 7c is pressed on leading edges 4a (such as when top 2 is pivoted to the closed position on body 1) such that leading edges 4a cut through insulator 7c and conductor 7d fits in slot 4b and contacts extensions 4c. Cable 7 is placed in channel C such that teeth 1c contact either outside shield 7b or outside insulation 7a (depending on size and how cable 7 is stripped). Top 2 is pivoted about hinge points 5a such that latch 1a engages latch hole 2a pressing cable 7 into teeth 1c. Teeth 1c either contact shield 7b directly or cut through insulation 7a to contact shield 7b to provide an electrical connection between shield 7b and ground plane 8 (which is the printed circuit board 8 in this case, but could be any conventional ground).

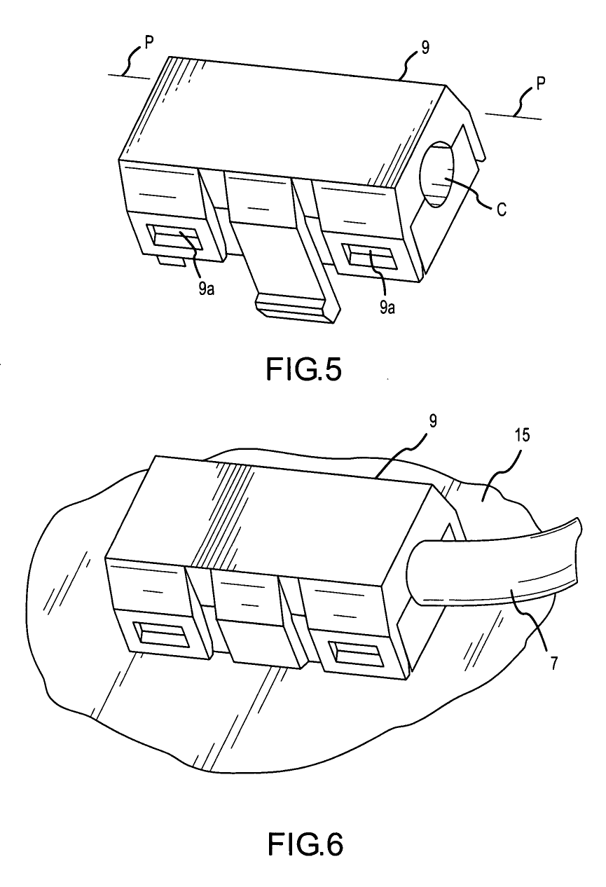

Referring now to FIGS. 5, 6 and 7, another embodiment of a cable connector 9 consistent with the present invention is shown. Connector 9 is similar to connector 5 but has either pivots about axis P parallel to center conductor 7d instead of perpendicular to center conductor, which is how connector 5 is arranged, or simply snaps onto a plurality of latch means 9a around body 10 and top 11. Latches 9a, which in this case are latch hooks 9p and detent 9d style latch mechanisms, otherwise known as a button latch, reside in multiple locations around connector 9. Note, the latch hooks 9p and/or detent 9d could be spring loaded if desired. Another configuration difference, is contact 12 has a contact beam 12d extends beneath body 10, which is functionally equivalent to contact 4 having portion 4e external to connector 5 (FIG. 7). FIG. 6 is similar to FIG. 5 but shows connector 9 attached to device, such as a printed circuit board 15 and cable 7.

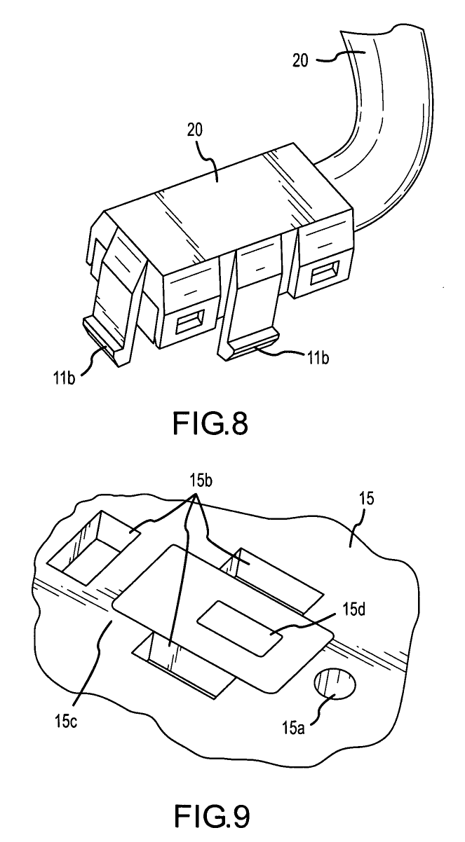

In this version, connector 9 is typically attached to cable 7 prior to attaching connector 9 to the device. The mechanical and electrical connections between connector 9 and cable 7 are similar to those for connector 5 and will not be further explained, herein. Connector 9 is attached to printed circuit board 15 by a latch, such as the cantilever beam latch 11 b shown (which comprises a beam and protrusion) fitting into corresponding holes 15b in printed circuit board 15 (shown in FIG. 9). Electrical contact between center conductor 7d and printed circuit board 15 is by center conductor 7d residing in slot 12b and a spring contact beam 12d contacting feed pad 15d on printed circuit board 15 (FIG. 9). FIGS. 5 and 6, and 8 and 9 are similar but FIGS. 5-7 shows one cantilever beam latch 11 b and FIGS. 8 and 9 shows several. Shield 7b (FIG. 13) is attached to a contact 12g (FIG. 7) that is connected to ground 15c (FIG. 9).

Similar to connector 5, connector 9 is used by partially stripping cable 7 and placing cable 7 in channel C. Top 10 is pivoted or snapped into the closed position on body 10. The electrical and mechanical connections are generally arranged similar to those in connector 5 and not re-explained herein. Once cable 7 is attached to connector 9, connector 9 is typically snapped onto circuit board 15. Attaching connector 9 to circuit board 15 may be facilitated by aligning a pilot hole 15a on circuit board 15 and a pin 10d on body 10.

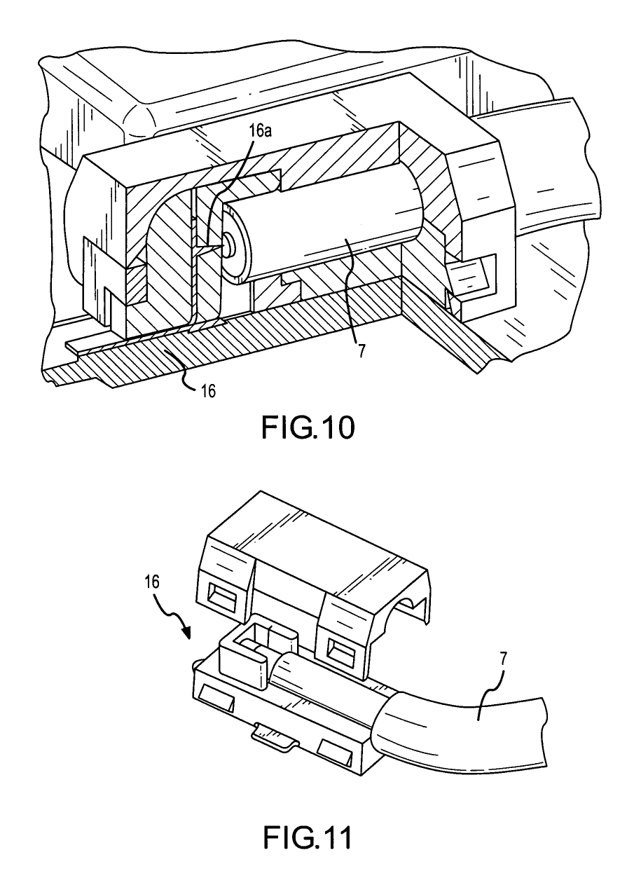

FIG. 10 shows an alternative contact 16. Contact 16 does not have a slot similar to contact s 4 and 12 above, but rather a contact probe 16a. Contact probe 16a is forced (similar to a push pin) into cable 7 until contact is made with conductor 7d. FIG. 11 shows the contact 16 in a connector with the top removed.

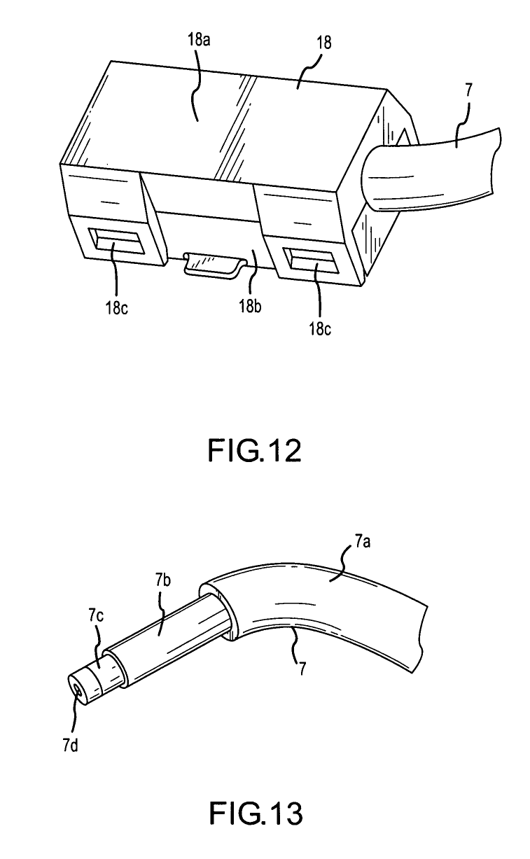

FIG. 12 shows another connector 18. Body 18b is similar to body 1 with regards to solder points and contacts, but instead of hinge connections top 18a snaps onto latches 18c, similar to connector 9.

FIG. 13 shows cable 7 and various components of cable 7. Cable 7 is conventional and will not be further explained except in regard to the specific invention and various embodiments thereof.

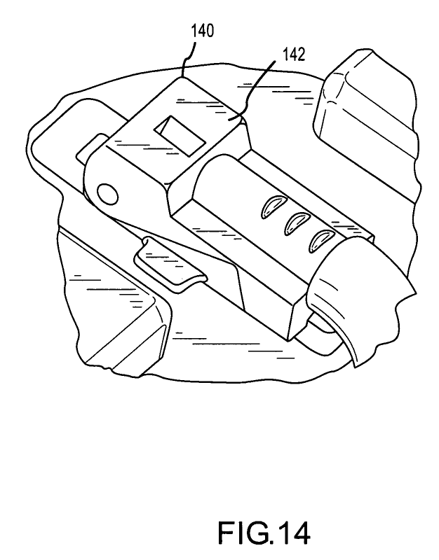

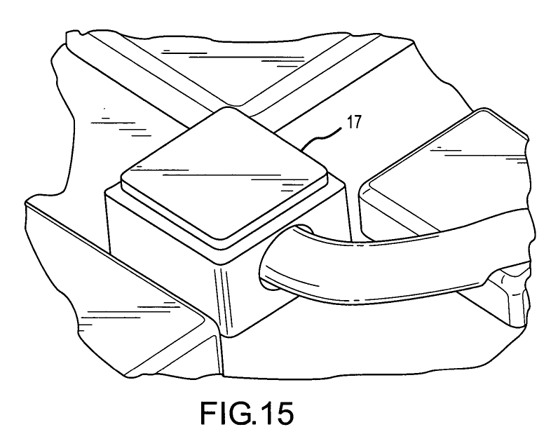

FIG. 14 shows an alternative connector 140. Connector 140 is similar to connector 5, but has a stamped metal top 142. Connector 140 will not be otherwise explained.

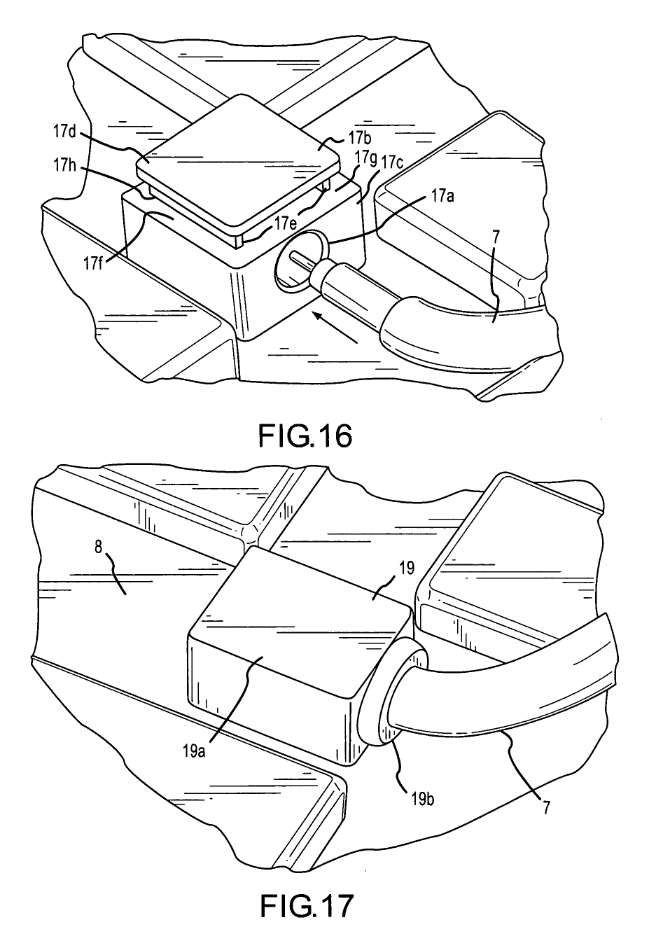

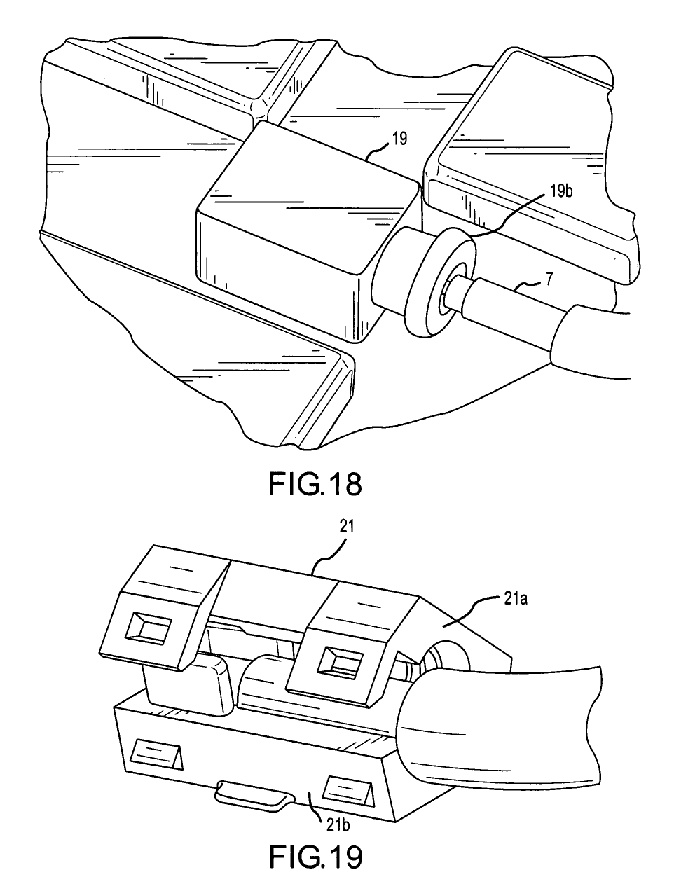

Referring now to FIGS. 15 and 16, a connector 17 consistent with another embodiment of the present invention is shown. Connector 17 functions similar to previously described connectors and only the differences will be explained herein. Connector 17 comprises a cable opening 17a, a body 17c, and a push actuator 17b. Push actuator 17b has a top 17d and legs 17e (in this case two legs are shown but more or less could be used). Legs 17e have an expanded bottom 17f (not specifically shown). Body 17b has a number of slots 17g corresponding to the number of legs 17e. Slots 17g have a width sufficient to fit expanded bottom 17f but shoulders 17h on the top surface of slots 17g prevent legs 17e from existing when expanded bottom 17f contacts shoulders 17h maintaining the coupling between push actuator 17c and body 17b. As seen in FIG. 17, cable 7 is pushed into opening 17a. Actuator 17b is pushed into body 17c. Otherwise, connector 17 functions similar to other connectors described above and will not be further explained herein.

FIGS. 17 and 18 show another connector 19, which is a variation of connector 17. As seen in FIG. 18, coaxial cable 7 is pushed into an actuator 19b. Actuator 19b is pushed into a connector body 19a as shown in FIG. 17. The mechanical and electrical connections are as described above.

FIGS. 19 shows connector 21. Connector 21 is similar to connectors 5 and/or 9. Unlike connector 9, which specifically shows the body and top snapping, connector 21 shows top 21a pivoting on body 21b.

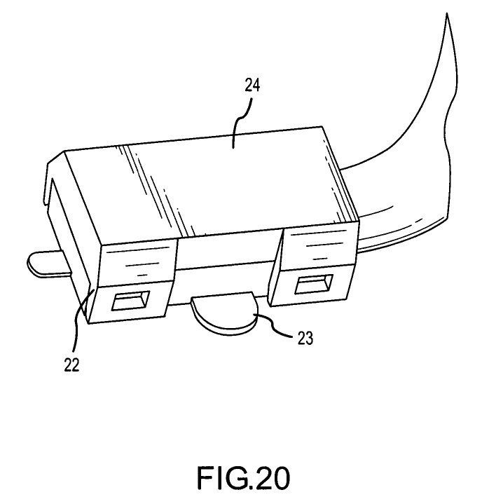

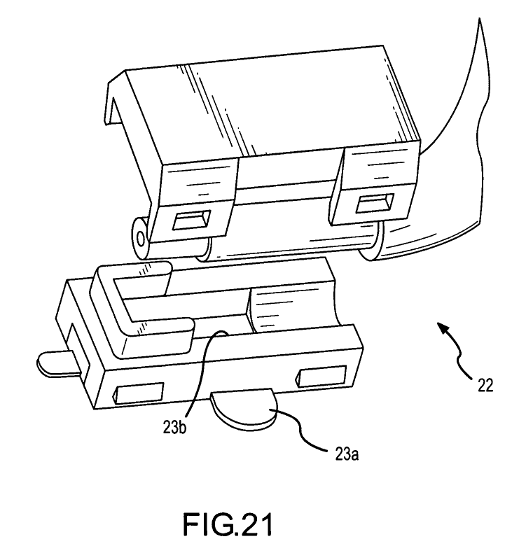

FIGS. 20 and 21 shows connector 22 that is still another embodiment of the present invention. Connector 22 is similar to connector 19 and the similarities will not be further explained. Unlike connector 19, however, connector 22 has a connector top 24 and base 22 made from a non-conductive plastic material. The plastic material is not metallized. A contact 23 is inserted into connector body 22. Contact 23 has two legs 23a soldered to the printed circuit board. When coaxial cable 7 is placed into connector body 22, pad 23b makes contact with shield 7b of the coaxial cable and provides the electrical path from the outside shield on the coaxial cable to the printed circuit board.

While the invention has been particularly shown and described with reference to an embodiment thereof, it will be understood by those skilled in the art that various other changes in the form and details may be made without departing from the spirit and scope of the invention.

What we claim:

1. A connector assembly, comprising:
a connector body;
a connector top, the connector top fittingly engaged to the connector body such that the connector assembly has an open position and an engaged position;
the connector body and the connector top defining a channel at least when in the engaged position, the channel for receiving a power feed, the power feed having a ground portion and a conductor portion;
at least one ground contact coupled to the connector body, the at least one ground contact engages a ground plane and the ground portion;
at least one power contact coupled to the connector body, the at least one power contact engages the conductor portion and a device; and
insulation to insulate the power contact and the ground contact, the ground plane, and the ground portion.

2. The connector assembly of claim 1, wherein the power feed comprises a coaxial cable having a shield and a central conductor, wherein the ground portion comprises at least the shield and the conductor portion comprises at least the central conductor.

3. The connector assembly of claim 1, wherein the connector top is pivotally coupled to the connector body.

4. The connector assembly of claim 3, wherein the pivotal connection comprises at least one protrusion in at least one detent.

5. The connector assembly of claim 4, wherein the at least one detent comprises at least one hole.

6. The connector assembly of claim 3, wherein the pivotal connection comprises at least one axle extending through a plurality of holes.

7. The connector assembly of claim 1, further comprising:
a latch means associated with the connector body and the connector top to latch the connector body and the connector top in the engaged position.

8. The connector assembly of claim 7, wherein the latch means comprises a latch protrusion removably coupled to a latch detent.

9. The connector assembly of claim 8, wherein the latch protrusion comprises a latch surface angled to facilitate coupling the latch protrusion with the latch detent.

10. The connector assembly of claim 8, wherein the latch detent comprises a latch surface angled to facilitate coupling the latch protrusion with the latch detent.

11. The connector assembly of claim 1, wherein the at least one ground contact comprises at least one channel protrusion connectable to the ground portion of the power feed.

12. The connector assembly of claim 11, wherein the at least one channel protrusion comprises a plurality of teeth.

13. The connector assembly of claim 2, wherein the at least one power contact comprises a slot for engaging the central conductor.

14. The connector assembly of claim 13, wherein the at least one power contract further comprises a leading edge to cut the coaxial cable and allow the slot to engage the central conductor.

15. The connector assembly of claim 1, wherein the connector body comprises at least one ground solder tab, the at least one ground solder tab coupled to the ground plane to connect the connector assembly to the device and provide the electrical connection between the at least one ground contact and the ground plane.

16. The connector assembly of claim 1, further comprising:
a body latch means associated with the connector body latchably coupled to the device.

17. The connector assembly of claim 16, wherein the body latch means comprises at least one arm, at least one device latch hole and at least one protrusion whereby the at least one latch arm extends through the device latch hole such that the at least one protrusion forms a snap lock with the device.

18. The connector assembly according to claim 1, wherein the device is selected from the group consisting of a printed circuit board, a radio, an antenna, a laptop computer, a desktop computer, an electronic game, a cellular telephone, a device, or a PDA.

19. The connector assembly according to claim 1, wherein the power contact is soldered to the device to provide power.

20. The connector assembly according to claim 1, wherein the power contact electrically engages the device by a spring contact.

21. A connector assembly, comprising
a connector body;
a connector top;
means for pivotally connecting the connector body to the connector top such that the connector body and connector top can be rotated between an open position and a closed position;
the connector body and connector top defining a channel when in the closed position, the channel operatively sized to receive a power feed;
at least one power contact coupled to the connector assembly, the at least one power contact including means to electrically couple a conductor of the received power feed to a device to receive power; and
at least one ground contact coupled to the connector assembly, the at least one ground contact including means to electrically couple a ground of the received power feed to a device ground.

22. The connector assembly of claim 21, wherein the means for pivotally connecting comprises at least one hole on the connector top aligned with at least one protrusion on the connector body.

23. The connector assembly of claim 21, wherein the means for pivotally connecting comprises at least one protrusion on the connector top aligned with at least one hole on the connector body.

24. The connector assembly of claim 21, wherein the means for pivotally connecting comprises at least one axle.

25. The connector assembly of claim 21, further comprising means for gripping the power feed, the means for gripping residing in the channel.

26. The connector assembly of claim 25, wherein the means for gripping the power feed comprises at least one protrusion.

27. The connector assembly of claim 26, wherein the at least one protrusion comprises a plurality of teeth.

28. The connector assembly of claim 21, wherein the means to electrically couple a conductor of the received power feed to a device comprises:
at least one contact, the at least one contact comprising:
an internal portion; and
an external portion, wherein
the internal portion comprises a plurality of extensions providing at least one slot wherein each of the plurality of extensions provides a leading edge, wherein the leading edge is to provide access to the conductor of the power feed and the at least one slot is to accept the conductor of the power feed and provide an electrical connection between conductor of the power feed and the at least one contact, and wherein
the external portion comprises a tab to provide an electrical connection to the device to receive power.

29. The conductor assembly of claim 21, wherein the means to electrically couple a conductor of the received power feed to a device comprises:
at least one contact, the at least one contact comprising:
an internal portion and an external portion, the internal portion comprising at least one protrusion to pierce the power feed and contact the conductor of the power feed, and the external portion to provide electrical coupling to the device to receive power.

30. The conductor assembly of claim 21, wherein the means to electrically couple a ground of the received power feed to a device ground comprises a plurality of teeth residing in the channel coupled to a ground tab, wherein the plurality of teeth engage the at ground of the received power feed and the ground tab is connected to the device ground.

31. A connector assembly, comprising:
a connector body;
a connector top;
means for removably connecting the connector body to the connector top such that the connector body and connector top connectably define a channel, the channel sized to receive a power feed, the power feed to comprise a feed conductor and a feed ground;
a first contact to couple the feed conductor to a device; and
a second contact to couple the feed ground to a device ground.

32. The connector assembly of claim 31, wherein the means for removably connecting the connector body to the connector top comprises at least one latch arm that operatively engages at least one latch detent.

33. The connector assembly of claim 32, wherein the at least one latch arm is coupled to the connector top and the at least one latch detent is coupled to the connector body.

34. The connector assembly of claim 32, wherein the at least one latch arm is coupled to the connector body and the at least one latch detent is coupled to the connector top.

35. The connector assembly of claim 32, wherein the at least one latch detent comprises at least one hole.

36. The connector assembly of claim 31, further comprising an insulative material between the feed conductor and the feed ground.

37. The connector assembly of claim 36, wherein the first contact comprises a first portion to operatively engage the feed conductor and a cutting portion to penetrate the insulative material such that the first portion operatively engages the feed conductor.

38. A connector assembly, comprising:
a connector body;
a channel defined by the connector body to receive a power feed;
an actuator slidably connected to the connector body, the actuator having at least a non-engaged position and an engaged position, such that when in the non-engaged position, the power feed can be removed and when in the engaged position, the power feed is held within the channel;
a first contact to couple a feed condutor of the power feed to a device, wherein the coupling is accomplished by moving the actuator from the non-engaged position to the engaged position; and
a second contact to couple a ground of the power feed to a device ground wherein the coupling is accomplished by moving the actuator from the non-engaged position to the engaged position.

39. The connector assembly of claim 38, wherein the body comprises:
at least one slot extending into the connector body, the at least one slot terminating in a shoulder; and wherein
the actuator comprises at least one leg extending in the slot and terminating in a lip such that the shoulder and the lip inhibit disengaging the actuator from the body.

40. The connector assembly of claim 38, wherein the actuator is slidably coupled in the channel.
